(19) United States
(12) Patent Application Publication
(10) Pub. No.: US 2025/0378576 A1
(43) Pub. Date: Dec. 11, 2025

(54) Method for Detecting Pick Point of Objects Based on 2D Vision Technology

(71) Applicant: VAZIL Company Co., Ltd., Busan (KR)

(72) Inventors: Sungwon KIM, Daegu (KR); Akhmadali Ugli Anvarjon TURSUNOV, Busan (KR)

(21) Appl. No.: 19/216,772

(22) Filed: May 23, 2025

(30) Foreign Application Priority Data
Jun. 11, 2024 (KR) 10-2024-0075370

(51) Int. Cl. G06T 7/73; G06V 10/26; G06V 10/44; G06V 10/82

(52) U.S. Cl. CPC G06T 7/73; G06V 10/26; G06V 10/44; G06V 10/82; G06T 2207/20081; G06T 2207/20084; G06V 2201/07

(57) ABSTRACT

Disclosed is a method for detecting an object based on a 2D vision technology, which is performed by a computing device. The method may include: acquiring 2D vision data; sensing the object in the acquired 2D vision data; acquiring feature information of the sensed object; and detecting the object by projecting at least some of the acquired feature information onto the 2D vision data.

### CROSS-REFERENCE TO RELATED APPLICATIONS

This application claims priority to and the benefit of Korean Patent Application No. 10-2024-0075370, filed on Jun. 11, 2024, which is incorporated by reference herein in its entirety.

### TECHNICAL FIELD

The present disclosure relates to a method for detecting an object based on a 2D vision technology, and particularly, to a technology of detecting a pick point of an object by utilizing 2D vision data and a deep learning model.

### BACKGROUND ART

Computer vision is a technical field in which a computer extracts and interprets information from an image and a video. In particular, object detection is an important research field in the computer vision and deals with techniques for automatically identifying and classifying specific objects in the image or video.

An existing 2D vision-based object detection method mainly utilizes a method of matching the image with a specific element. Exemplarily, a feature-based detection method extracts a feature of an image, such as a corner or a corner point, to detect an object. Alternatively, a template-based detection method is a method of comparing a predefined template image and an input image to find a matching object. However, the methods have a problem of low accuracy in a complicated situation, a problem of requiring manual work, a problem of insufficient generalization ability, or the like.

Therefore, in recent years, through the development of machine learning and deep learning technologies, technologies for improving the performance of the 2D vision-based object detection method by utilizing an artificial neural network model have been developed.

Korean Patent Application Publication No. 2022-0102381 (Publication Date: Jul. 20, 2022) discloses a 2D Lidar-based tracking object detect method and apparatus.

### SUMMARY OF THE INVENTION

The present disclosure has been made in an effort to provide a method for detecting an object based on a 2D vision technology. For example, the present disclosure has been made in an effort to sense an object (e.g., a large object) by using 2D vision data and a deep learning model, thereby increasing data collection and processing efficiency, and to detect a pick point of the object by acquiring feature information of the object, thereby improving detection accuracy and adaptability to complex situations.

On the other hand, the technical problem to be achieved by the present disclosure is not limited to the technical problem mentioned above, and various technical problems may be included within the range obvious to those skilled in the art from the content to be described below.

An exemplary embodiment of the present disclosure provides a method for detecting an object based on a 2D vision technology, which is performed by a computing device. The method may include: acquiring 2D vision data; sensing an object in the acquired 2D vision data; acquiring feature information of the sensed object; and detecting the object by projecting at least some of the acquired feature information onto the 2D vision data.

Alternatively, the sensing of the object in the acquired 2D vision data may include acquiring oriented information of the object.

Alternatively, the sensing of the object in the acquired 2D vision data may further include sensing the object by utilizing turned real-time models for object detection (RTMDet).

Alternatively, the sensing of the object in the acquired 2D vision data may include acquiring midline points of the object.

Alternatively, the sensing of the object in the acquired 2D vision data may further include segmenting the object in the 2D vision data, and the segmentation may utilize a zero-shot image segmentation method.

Alternatively, the sensing of the object in the acquired 2D vision data may further include segmenting the object in the 2D vision data, and the segmentation may utilize a segment anything model (SAM).

Alternatively, the acquiring of the feature information of the sensed object may include acquiring contour information of the segmented object.

Alternatively, the acquiring of the feature information of the sensed object may further include acquiring a center point of the segmented object.

Alternatively, the acquiring of the 2D vision data may include receiving the 2D vision data, and preprocessing the 2D vision data.

Alternatively, the object may be a large object has a size equal to or greater than a preset threshold.

Another exemplary embodiment of the present disclosure provides a computer program stored in a non-transitory computer-readable storage medium. When the computer program is executed by one or more processors, the computer program may allows the one or more processors to perform operations for detecting an object based on a 2D vision technology, and the operations may include: an operation of acquiring 2D vision data; an operation of sensing the object in the acquired 2D vision data; an operation of acquiring feature information of the sensed object; and an operation of detecting the object by projecting at least some of the acquired feature information onto the 2D vision data.

Alternatively, the operation of sensing the object in the acquired 2D vision data may include an operation of acquiring oriented information of the object.

Alternatively, the operation of sensing the object in the acquired 2D vision data may further include an operation of sensing the object by utilizing turned real-time models for object detection (RTMDet).

Alternatively, the operation of sensing the object in the acquired 2D vision data may include an operation of acquiring midline points of the object.

Alternatively, the operation of sensing the object in the acquired 2D vision data may further include an operation of segmenting the object in the 2D vision data, and the segmentation may utilize a zero-shot image segmentation method.

Alternatively, the operation of sensing the object in the acquired 2D vision data may further include an operation of segmenting the object in the 2D vision data, and the segmentation may utilize a segment anything model (SAM).

Alternatively, the operation of acquiring the feature information of the sensed object may include an operation of acquiring contour information of the segmented object.

Alternatively, the operation of acquiring the feature information of the sensed object may further include an operation of acquiring a center point of the segmented object.

Alternatively, the operation of acquiring the 2D vision data may include an operation of receiving the 2D vision data, and an operation of preprocessing the 2D vision data.

Alternatively, the object may be a large object has a size equal to or greater than a preset threshold.

Yet another exemplary embodiment of the present disclosure provides a computing device. The device may include: at least one processor; and a memory, and the processor may be configured to acquire 2D vision data, sense an object in the acquired 2D vision data, acquire feature information of the sensed object, and detect the object by projecting at least some of the acquired feature information onto the 2D vision data.

Still yet another exemplary embodiment of the present disclosure provides a data structure included in a computer-readable storage medium. The data structure may correspond to a parameter of a neural network, and the neural network may perform the following steps at least partially based on the parameter, and the steps may include: acquiring 2D vision data; sensing an object in the acquired 2D vision data; acquiring feature information of the sensed object; and detecting the object by projecting at least some of the acquired feature information onto the 2D vision data.

According to an exemplary embodiment of the present disclosure, a 2D vision-based object detection solution can be provided. For example, according to an exemplary embodiment of the present disclosure, an object (e.g., a large object) is sensed by using 2D vision data and a deep learning model, thereby increasing data collection and processing efficiency, and the object is detected by acquiring feature information of the object, thereby improving detection accuracy and adaptability to complex situations.

On the other hand, the effect of the present disclosure is not limited to the above-mentioned effects, and various effects may be included within the range apparent to those skilled in the art from the content to be described below.

### BRIEF DESCRIPTION OF THE DRAWINGS

FIG. 1 is a block diagram of a computing device for detecting an object based on a 2D vision technology according to an exemplary embodiment of the present disclosure.

FIG. 2 is a conceptual view illustrating a neural network according to an exemplary embodiment of the present disclosure

FIG. 3A is a schematic flowchart of a method for detecting an object based on a 2D vision technology according to an exemplary embodiment of the present disclosure.

FIG. 3B is a detailed flowchart of a method for detecting an object based on a 2D vision technology according to an exemplary embodiment of the present disclosure.

FIG. 4 is a schematic diagram for describing a step of sensing an oriented object according to an exemplary embodiment of the present disclosure.

FIG. 5 is a flowchart for describing a step of calculating a midline point according to an exemplary embodiment of the present disclosure.

FIG. 6 is a schematic diagram for describing a method for detecting an object based on a 2D vision technology for multiple objects according to an exemplary embodiment of the present disclosure.

FIG. 7 is a schematic diagram for describing a method for detecting an object based on a 2D vision technology for a single object according to an exemplary embodiment of the present disclosure.

FIG. 8 is a simplified general schematic diagram of an exemplary computing environment in which the embodiments of the present disclosure may be implemented.

### DETAILED DESCRIPTION

Various exemplary embodiments are described with reference to the drawings. In the present specification, various descriptions are presented for understanding the present disclosure. However, it is obvious that the exemplary embodiments may be carried out even without a particular description.

Terms, “component”, “module”, “system”, and the like used in the present specification indicate a computer-related entity, hardware, firmware, software, a combination of software and hardware, or execution of software. For example, a component may be a procedure executed in a processor, a processor, an object, an execution thread, a program, and/or a computer, but is not limited thereto. For example, both an application executed in a computing device and a computing device may be components. One or more components may reside within a processor and/or an execution thread. One component may be localized within one computer. One component may be distributed between two or more computers. Further, the components may be executed by various computer readable media having various data structures stored therein. For example, components may communicate through local and/or remote processing according to a signal (for example, data transmitted to another system through a network, such as the Internet, through data and/or a signal from one component interacting with another component in a local system and a distributed system) having one or more data packets.

Further, a term “or” intends to mean comprehensive “or” not exclusive “or”. That is, unless otherwise specified or when it is unclear in context, “X uses A or B” intends to mean one of the natural comprehensive substitutions. That is, in the case where X uses A; X uses B; or, X uses both A and B, “X uses A or B” may apply to either of these cases. Further, a term “and/or” used in the present specification shall be understood to designate and include all of the possible combinations of one or more items among the listed relevant items.

Further, a term “include” and/or “including” shall be understood as meaning that a corresponding characteristic and/or a constituent element exists. Further, it shall be understood that a term “include” and/or “including” means that the existence or an addition of one or more other characteristics, constituent elements, and/or a group thereof is not excluded. Further, unless otherwise specified or when it is unclear that a single form is indicated in context, the singular shall be construed to generally mean “one or more” in the present specification and the claims.

Further, the term “at least one of A and B” should be interpreted to mean “the case including only A”, “the case including only B”, and “the case where A and B are combined”.

Those skilled in the art shall recognize that the various illustrative logical blocks, configurations, modules, circuits, means, logic, and algorithm operations described in relation to the exemplary embodiments additionally disclosed herein may be implemented by electronic hardware, computer software, or in a combination of electronic hardware and computer software. In order to clearly exemplify interchangeability of hardware and software, the various illustrative components, blocks, configurations, means, logic, modules, circuits, and operations have been generally described above in the functional aspects thereof. Whether the functionality is implemented as hardware or software depends on a specific application or design restraints given to the general system. Those skilled in the art may implement the functionality described by various methods for each of the specific applications. However, it shall not be construed that the determinations of the implementation deviate from the range of the contents of the present disclosure.

The description about the presented exemplary embodiments is provided so as for those skilled in the art to use or carry out the present disclosure. Various modifications of the exemplary embodiments will be apparent to those skilled in the art. General principles defined herein may be applied to other exemplary embodiments without departing from the scope of the present disclosure. Therefore, the present disclosure is not limited to the exemplary embodiments presented herein. The present disclosure shall be interpreted within the broadest meaning range consistent to the principles and new characteristics presented herein.

In the present disclosure, a network function and an artificial neural network and a neural network may be interchangeably used.

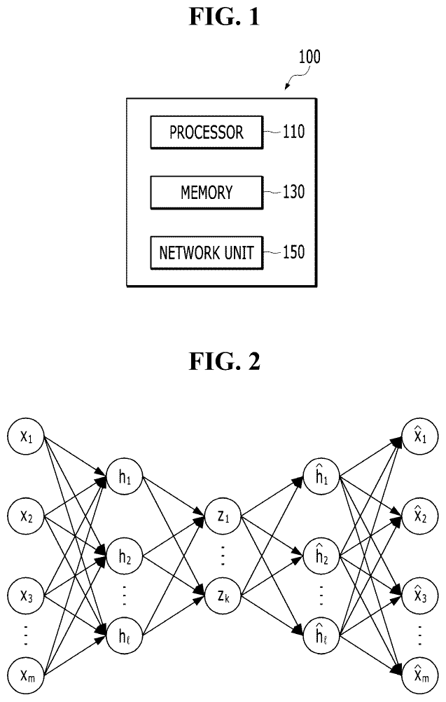

FIG. 1 is a block diagram of a computing device for detecting an object based on a 2D vision technology according to an exemplary embodiment of the present disclosure.

A configuration of the computing device 100 illustrated in FIG. 1 is only an example shown through simplification. In an exemplary embodiment of the present disclosure, the computing device 100 may include other components for performing a computing configuration of the computing device 100 and only some of the disclosed components may constitute the computing device 100.

The computing device 100 may include a processor 110, a memory 130, and a network unit 150.

The processor 110 may be constituted by one or more cores, and include processors for data analysis and deep learning, such as a central processing unit (CPU), a general purpose graphics processing unit (GPGPU), a tensor processing unit (TPU), etc., of the computing device. The processor 110 may read a computer program stored in the memory 130 and process data for machine learning according to an exemplary embodiment of the present disclosure. According to an exemplary embodiment of the present disclosure, the processor 110 may perform an operation for learning the neural network. The processor 110 may perform calculations for learning the neural network, which include processing of input data for learning in deep learning (DL), extracting a feature in the input data, calculating an error, updating a weight of the neural network using backpropagation, and the like.

At least one of the CPU, the GPGPU, and the TPU of the processor 110 may process learning of the network function. For example, the CPU and the GPGPU may process the learning of the network function and data classification using the network function jointly. In addition, in an exemplary embodiment of the present disclosure, the learning of the network function and the data classification using the network function may be processed by using processors of a plurality of computing devices together. In addition, the computer program performed by the computing device according to an exemplary embodiment of the present disclosure may be a CPU, GPGPU, or TPU executable program.

According to an exemplary embodiment of the present disclosure, the memory 130 may store any type of information generated or determined by the processor 110 and any type of information received by the network unit 150.

According to an exemplary embodiment of the present disclosure, the memory 130 may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the present disclosure is not limited thereto.

The network unit 150 according to several embodiments of the present disclosure may use various wired communication systems, such as a Public Switched Telephone Network (PSTN), an x Digital Subscriber Line (xDSL), a Rate Adaptive DSL (RADSL), a Multi Rate DSL (MDSL), a Very High Speed DSL (VDSL), a Universal Asymmetric DSL (UADSL), a High Bit Rate DSL (HDSL), and a local area network (LAN).

The network unit 150 presented in the present specification may use various wireless communication systems, such as Code Division Multi Access (CDMA), Time Division Multi Access (TDMA), Frequency Division Multi Access (FDMA), Orthogonal Frequency Division Multi Access (OFDMA), Single Carrier-FDMA (SC-FDMA), and other systems.

In the present disclosure, the network unit 150 may be configured regardless of a communication aspect, such as wired communication and wireless communication, and may be configured by various communication networks, such as a Personal Area Network (PAN) and a Wide Area Network (WAN). Further, the network may be a publicly known World Wide Web (WWW), and may also use a wireless transmission technology used in short range communication, such as Infrared Data Association (IrDA) or Bluetooth.

In the present disclosure, the network unit (150) can utilize various forms of wired and wireless communication systems.

The technologies described in this specification can be used not only in the mentioned networks but also in other networks.

When an element or layer is referred to as “on” or “above” another element or layer, this includes both directly on top of another element or layer as well as with another layer or another element interposed in the middle. On the other hand, when a component is referred to as “directly on” or “directly above” it indicates that there is no other component or layer intervening.

The spatially relative terms “below,” “beneath,” “lower,” “above,” “upper,” and the like may be used to facilitate the description of one component or its relationship to other components as shown in the drawings. Spatially relative terms should be understood to include different orientations of an element in use or operation in addition to the orientations shown in the drawings.

For example, a component described as “below” or “beneath” another component may be placed “above” another component when the components shown in the drawing are inverted. Thus, the exemplary term “below” can include both below and above orientations. Components may also be oriented in other directions, and accordingly, spatially relative terms may be interpreted according to their orientation.

Further, as used herein, the terms “apparatus” and “device” may often be used interchangeably.

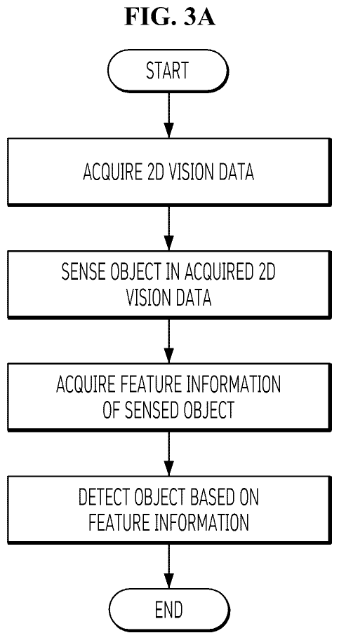

FIG. 2 is a conceptual view illustrating a neural network according to an exemplary embodiment of the present disclosure

Throughout the present specification, the meanings of a calculation model, a nerve network, the network function, and the neural network may be interchangeably used. The neural network may be formed of a set of interconnected calculation units which are generally referred to as “nodes”. The “nodes” may also be called “neurons”. The neural network consists of one or more nodes. The nodes (or neurons) configuring the neural network may be interconnected by one or more links.

In the neural network, one or more nodes connected through the links may relatively form a relationship of an input node and an output node. The concept of the input node is relative to the concept of the output node, and a predetermined node having an output node relationship with respect to one node may have an input node relationship in a relationship with another node, and a reverse relationship is also available. As described above, the relationship between the input node and the output node may be generated based on the link. One or more output nodes may be connected to one input node through a link, and a reverse case may also be valid.

In the relationship between an input node and an output node connected through one link, a value of the output node data may be determined based on data input to the input node. Herein, a link connecting the input node and the output node may have a weight. The weight is variable, and in order for the neural network to perform a desired function, the weight may be varied by a user or an algorithm. For example, when one or more input nodes are connected to one output node by links, respectively, a value of the output node may be determined based on values input to the input nodes connected to the output node and weights set in the link corresponding to each of the input nodes.

As described above, in the neural network, one or more nodes are connected with each other through one or more links to form a relationship of an input node and an output node in the neural network. A characteristic of the neural network may be determined according to the number of nodes and links in the neural network, a correlation between the nodes and the links, and a value of the weight assigned to each of the links. For example, when there are two neural networks in which the numbers of nodes and links are the same and the weight values between the links are different, the two neural networks may be recognized to be different from each other.

The neural network may consist of a set of one or more nodes. A subset of the nodes configuring the neural network may form a layer. Some of the nodes configuring the neural network may form one layer on the basis of distances from an initial input node. For example, a set of nodes having a distance of n from an initial input node may form n layers. The distance from the initial input node may be defined by the minimum number of links, which need to be passed to reach a corresponding node from the initial input node. However, the definition of the layer is arbitrary for the description, and a degree of the layer in the neural network may be defined by a different method from the foregoing method. For example, the layers of the nodes may be defined by a distance from a final output node.

The initial input node may mean one or more nodes to which data is directly input without passing through a link in a relationship with other nodes among the nodes in the neural network. Otherwise, the initial input node may mean nodes which do not have other input nodes connected through the links in a relationship between the nodes based on the link in the neural network. Similarly, the final output node may mean one or more nodes that do not have an output node in a relationship with other nodes among the nodes in the neural network. Further, the hidden node may mean nodes configuring the neural network, not the initial input node and the final output node.

In the neural network according to the embodiment of the present disclosure, the number of nodes of the input layer may be the same as the number of nodes of the output layer, and the neural network may be in the form that the number of nodes decreases and then increases again from the input layer to the hidden layer. Further, in the neural network according to another embodiment of the present disclosure, the number of nodes of the input layer may be smaller than the number of nodes of the output layer, and the neural network may be in the form that the number of nodes decreases from the input layer to the hidden layer. Further, in the neural network according to another embodiment of the present disclosure, the number of nodes of the input layer may be larger than the number of nodes of the output layer, and the neural network may be in the form that the number of nodes increases from the input layer to the hidden layer. The neural network according to another embodiment of the present disclosure may be the neural network in the form in which the foregoing neural networks are combined.

A deep neural network (DNN) may mean the neural network including a plurality of hidden layers, in addition to an input layer and an output layer. When the DNN is used, it is possible to recognize a latent structure of data. That is, it is possible to recognize latent structures of photos, texts, videos, voice, and music (for example, what objects are in the photos, what the content and emotions of the texts are, and what the content and emotions of the voice are). The DNN may include a convolutional neural network (CNN), a recurrent neural network (RNN), an auto encoder, Generative Adversarial Networks (GAN), a Long Short-Term Memory (LSTM), a transformer, a restricted Boltzmann machine (RBM), a deep belief network (DBN), a Q network, a U network, a Siamese network, a Generative Adversarial Network (GAN), and the like. The foregoing description of the deep neural network is merely illustrative, and the present disclosure is not limited thereto.

In the embodiment of the present disclosure, the network function may include an auto encoder. The auto encoder may be one type of artificial neural network for outputting output data similar to input data. The auto encoder may include at least one hidden layer, and the odd-numbered hidden layers may be disposed between the input/output layers. The number of nodes of each layer may decrease from the number of nodes of the input layer to an intermediate layer called a bottleneck layer (encoding), and then be expanded symmetrically with the decrease from the bottleneck layer to the output layer (symmetric with the input layer). The auto encoder may perform a nonlinear dimension reduction. The number of input layers and the number of output layers may correspond to the dimensions after preprocessing of the input data. In the auto encoder structure, the number of nodes of the hidden layer included in the encoder decreases as a distance from the input layer increases. When the number of nodes of the bottleneck layer (the layer having the smallest number of nodes located between the encoder and the decoder) is too small, the sufficient amount of information may not be transmitted, so that the number of nodes of the bottleneck layer may be maintained in a specific number or more (for example, a half or more of the number of nodes of the input layer and the like).

The neural network may be trained by at least one scheme of supervised learning, unsupervised learning, semi-supervised learning, and reinforcement learning. The training of the neural network may be a process of applying knowledge for the neural network to perform a specific operation to the neural network.

The neural network may be trained in a direction of minimizing an error of an output. In the training of the neural network, training data is repeatedly input to the neural network and an error of an output of the neural network for the training data and a target is calculated, and the error of the neural network is back-propagated in a direction from an output layer to an input layer of the neural network in order to decrease the error, and a weight of each node of the neural network is updated. In the case of the supervised learning, training data labelled with a correct answer (that is, labelled training data) is used, in each training data, and in the case of the unsupervised learning, a correct answer may not be labelled to each training data. That is, for example, the training data in the supervised learning for data classification may be data, in which category is labelled to each of the training data. The labelled training data is input to the neural network and the output (category) of the neural network is compared with the label of the training data to calculate an error. For another example, in the case of the unsupervised learning related to the data classification, training data that is the input is compared with an output of the neural network, so that an error may be calculated. The calculated error is back-propagated in a reverse direction (that is, the direction from the output layer to the input layer) in the neural network, and a connection weight of each of the nodes of the layers of the neural network may be updated according to the backpropagation. A change amount of the updated connection weight of each node may be determined according to a learning rate. The calculation of the neural network for the input data and the backpropagation of the error may configure a learning epoch. The learning rate is differently applicable according to the number of times of repetition of the learning epoch of the neural network. For example, at the initial stage of the learning of the neural network, a high learning rate is used to make the neural network rapidly secure performance of a predetermined level and improve efficiency, and at the latter stage of the learning, a low learning rate is used to improve accuracy.

In the training of the neural network, the training data may be generally a subset of actual data (that is, data to be processed by using the trained neural network), and thus an error for the training data is decreased, but there may exist a learning epoch, in which an error for the actual data is increased. Overfitting is a phenomenon, in which the neural network excessively learns training data, so that an error for actual data is increased. For example, a phenomenon, in which the neural network learning a cat while seeing a yellow cat cannot recognize cats, other than a yellow cat, as cats, is a sort of overfitting. Overfitting may act as a reason of increasing an error of a machine learning algorithm. In order to prevent overfitting, various optimizing methods may be used. In order to prevent overfitting, a method of increasing training data, a regularization method, a dropout method of inactivating a part of nodes of the network during the training process, a method using a bath normalization layer, and the like may be applied.

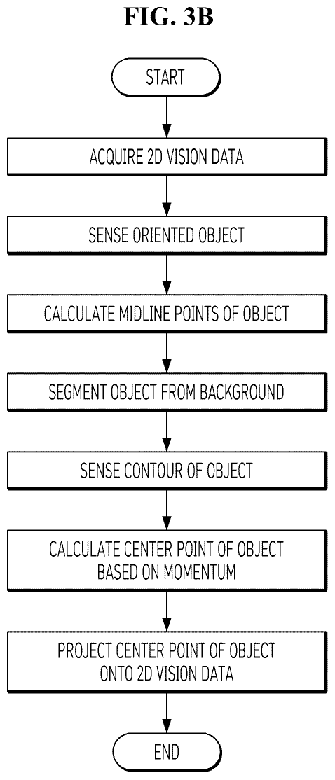

FIGS. 3A and 3B are flowcharts illustrating a method for detecting an object based on a 2D vision technology according to an exemplary embodiment of the present disclosure.

A computing device 100 according to an exemplary embodiment of the present disclosure may directly acquire 2D vision data or receive and acquire the 2D vision data from an external system. The external system may be a server, database, or the like that stores and manages the 2D vision data for detecting an object. The computing device 100 may use the data acquired directly or received from the external system as “2D vision data for detecting the object”. The computing device 100 according to an exemplary embodiment of the present disclosure may control performance of a method for detecting an object based on a 2D vision technology to be described below. In the present disclosure, the 2D vision data may include image or video data.

Exemplarily referring first to FIG. 3A, the method for detecting an object based on a 2D vision technology may include a step (S110) of acquiring 2D vision data, a step (S120) of sensing an object in the acquired 2D vision data, a step (S130) of acquiring feature information of the sensed object, a step (S140) detecting the object based on the acquired feature information, and the like.

Step S110 is a step of acquiring the 2D vision data. Exemplarily, the computing device 100 may directly acquire the 2D vision data or receive and acquire the 2D vision data from an external system. As an example, the external system may be a server or database that stores and manages the 2D vision data for detecting the object.

As an example, the computing device 100 may directly acquire the 2D vision data by controlling driving of a linked 2D camera. Alternatively, the computing device 100 may acquire the 2D vision data by receiving 2D vision data of an object photographed by a 2D camera separately provided outside.

Additionally, the method may include a step in which the computing device 100 preprocesses the 2D vision data in the step of acquiring the 2D vision data. In this case, the preprocessing of the 2D vision data may be performed for a purpose of improving the efficiency of the step (S120) of sensing the object. As an example, the preprocessing of the 2D vision data may be a scheme of normalizing a pixel value of the 2D vision data to 0 or 1. According to an exemplary embodiment, the preprocessing of the 2D vision data may include a step of adjusting a size of the 2D vision data to a size of 1024×1024 pixels. However, the method for preprocessing the 2D vision data is not limited to the presented scheme, and various schemes available to those skilled in the art in the field of data preprocessing may be utilized. As an example, the object may be a large object used for shipbuilding automation. In this case, exemplarily, the shipbuilding process may be at least one of cutting, machining, painting, molding, or joining and assembling. Further, the object may be a large object has a size equal to or greater than a preset threshold. Exemplarily, the preset threshold may be set within a range defined by a maximum width of 7 m and a maximum height of 3 meters. As an example, the threshold may be preset to a width of 2 meters and a height of 1 meters, and the object may be limited to a large object having a size equal to or greater than the preset threshold. According to an exemplary embodiment of the present disclosure, a field of view (FOV) of the 2D camera may be 4.9 m in width and 3.27 m in height when a photographing target and the 2D camera are located at a distance of 3 m. As an example, when two 2D cameras are used at the same time, when the photographing target and the 2D camera are located at a distance of 3 m, the FOV may be 9.8 m in width and 3.27 m in height. In this case, two 2D cameras may be utilized to photograph a large object.

Step S120 is a step of sensing the object in the acquired 2D vision data. Exemplarily, the computing device 100 may sense the object in the 2D vision data by utilizing an artificial neural network model.

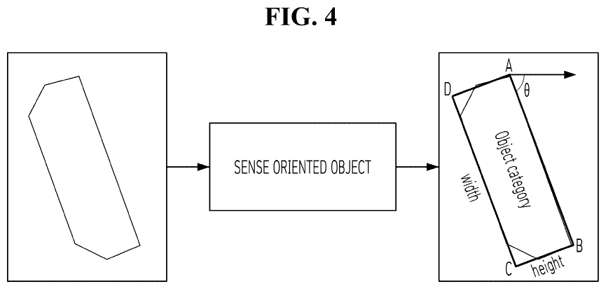

According to an exemplary embodiment of the present disclosure, the computing device 100 may sense an oriented object including oriented information of the object in the 2D vision data. The oriented object described in the present disclosure may include the oriented information of the object. In this case, the oriented information may include information about a direction or a rotation of a specific object. Further, the oriented object may be primarily utilized to identify and track an object in a rotated state. As an example, referring to FIG. 4, the computing device 100 may sense an object in the form of a box, and acquire direction and rotation information of the sensed object.

According to an exemplary embodiment of the present disclosure, the computing device 100 may sense the oriented object which is present in the 2D vision data by utilizing the artificial neural network model. As an example, the model utilized for sensing the oriented object may be real-time models for object detection (RTMDet). Furthermore, the computing device 100 may fine-tune and utilize the RTMDet to sense the oriented object in the 2D vision data. Exemplarily, the computing device 100 may sense the oriented object in the form of a box. According to the present disclosure, by training a model for sensing the oriented object to adapt to a new environment and an object, it is possible to improve the adaptability and efficiency of object detection, thereby easily maintaining the performance of the 2D vision-based object detection method according to the present disclosure, and ensuring excellent adaptability to various environments.

According to an exemplary embodiment of the present disclosure, the computing device 100 may acquire, for a sensed object, a midline point of the object by utilizing the artificial neural network model. Exemplarily, when the oriented object is sensed in the form of the box by the artificial neural network model, the midline points may be acquired for the box form. In the present disclosure, the midline point may be a point that is present above the midline and within the object. In addition, the midline points may be projected onto the 2D vision data. Exemplarily, the midline may be a line that passes through the center point of the coordinates of a detected box-shaped region. Furthermore, the midline may be displayed parallel to a pair of sides of the box that are parallel to each other and have a length greater than or equal to that of the other two sides among the four sides of the box.

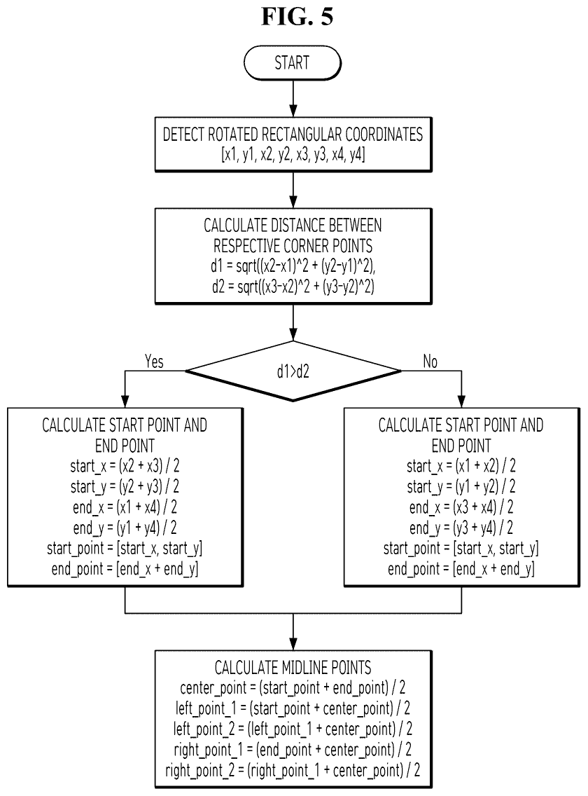

As an example, referring to FIG. 5, when the oriented object is sensed in the box form, the computing device 100 may acquire coordinates of respective corner points in the box form, and indicate the coordinates of the respective corner points as (x1, y1), (x2, y2), (x3, y3), and (x4, y4). Further, the coordinates of the corner points may be utilized to determine lengths of two adjacent sides of the box-form four sides. In addition, a start point or an end point of a midline may be acquired by acquiring a mean of coordinates of a side having a relatively short length (a side randomly selected when the lengths of the two sides are the same) among the two sides. Further, the start point or the end point of the midline may be acquired by acquiring a mean of coordinates of the other side parallel to the side having a relatively short length (a side randomly selected when the lengths of the two sides are the same) among the box-form four sides. In this case, points located at both ends of the middle line may be defined as the start point and the end point, respectively. Exemplarily, the box-form midline may be a line connecting the start point and the end point of the midline. As an example, the midline point may include a center_point. The center point may be acquired by averaging coordinates of the start point and the end point of the midline. As an example, the midline point may include left_point_1. Coordinates of the left_point_1 may be acquired by averaging coordinates of the start point and the center point. As an example, the midline point may include left_point_2. Coordinates of the left_point_2 may be acquired by obtaining a mean of the coordinates of left point_1 and the center point. As an example, the midline point may include right point_1. Coordinates of the right point_1 may be acquired by obtaining a mean of coordinates of the end point and the center_point. As an example, the midline point may include right_point_2. Coordinates of the right_point_2 may be acquired by obtaining a mean of the coordinates of the right point_1 and the center_point.

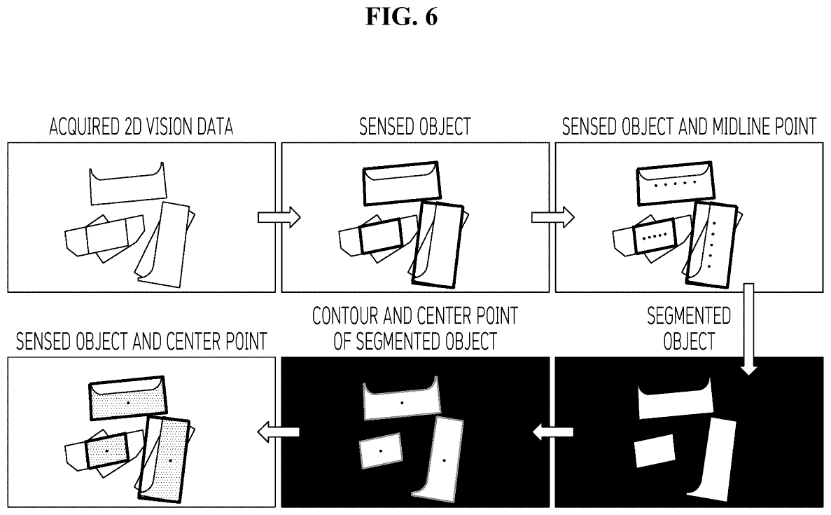

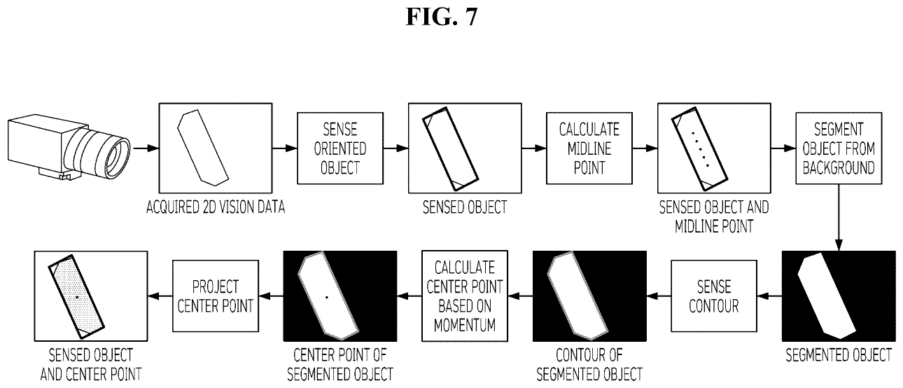

According to an exemplary embodiment of the present disclosure, the computing device 100 may segment the sensed object from other portions. Exemplarily, the computing device 100 may segment the sensed object from other portions by utilizing the artificial neural network model. According to an exemplary embodiment, referring to FIGS. 6 and 7, the computing device 100 may segment the object sensed in the process of step S120 and the remaining portion other than the object.

As an example, the computing device 100 may utilize a zero-shot image segmentation method to segment the object sensed in the 2D vision data. Exemplarily, the zero-shot image segmentation method may be a method of segmenting an image of a new class without labeling or learning. As an example, when the computing device 100 utilizes the zero-shot image segmentation method for the segmentation, the computing device 100 may have few needs to label the new class of image, and may segment various classes of images, and improve processing speed and accuracy of the segmentation.

As an example, the computing device 100 may utilize a segment anything model (SAM) in order to segment the object sensed in the 2D vision data. Exemplarily, the SAM may be a model developed by Meta that automatically segments a desired object in an image without pre-labeling. As an example, the SAM may be a model that utilizes a transformer-based neural network architecture. Further, when the computing device 100 utilizes the SAM for the segmentation, the computing device 100 may segment the object with high quality without requiring training for the segmentation of the object.

Step S130 is a step of acquiring feature information of the sensed object. Exemplarily, the computing device 100 may acquire feature information such as a contour or a center point.

According to an exemplary embodiment of the present disclosure, the computing device 100 may acquire a contour of the object segmented in step S120. Exemplarily, the contour may correspond to an actual contour of the object. In addition, the contour may not match the box form sensed in step S120, depending on the form of the object. As an example, the computing device 100 may detect the contour by scanning binary mask data pixel by pixel. Further, the binary mask data may be image data in which each pixel has a value of 0 or 1 as a binarized image. Alternatively, the binary mask data is binarized image data, and may be image data in which each pixel is black or white. In addition, the computing device 100 may recursively confirm a pixel having a value of 1 that is adjacent when a pixel having the value of 1 is found. Alternatively, the computing device 100 may recursively confirm adjacent white pixels if a white pixel is found.

According to an exemplary embodiment of the present disclosure, the computing device 100 may acquire the center point of the object. Exemplarily, the center point may be a momentum-based center point, a mass center point, or a coordinate center point. As an example, the computing device 100 calculates various moments of the contour describing a pixel distribution of the object to acquire the momentum-based center point. As an example, the computing device 100 may calculate coordinates of the momentum-based center point by dividing a weighted sum of x and y coordinates of the pixel in the contour by an area inside the contour. In the present disclosure, the moment may mean a form, a position, a mean value, a variance value, or variability of the distribution.

Step S140 is a step of detecting the object based on the acquired feature information. Exemplarily, the computing device 100 may detect the object by projecting the acquired feature information onto the 2D vision data. As an example, the feature information may include at least one of the contour or the center point. As an example, the computing device 100 may detect the object by sensing a pick point of the object. Furthermore, the pick point may correspond to the center point included in the feature information.

The pick point in the present disclosure may exemplarily mean a point targeted by a robot to grip a specific object in a robotics and automation system. As an example, the pick point may be an appropriate point for gripping a large object in shipbuilding automation. Further, the appropriate point for gripping the large object may be a point that considers the center of gravity of the object for grip stability. Alternatively, exemplarily, the pick point may be a point at which an object that is a specific part is selected and processed in an assembly line. As an example, the pick point may be a point at which the large object is selected and processed in a field of the shipbuilding automation.

According to an exemplary embodiment of the present disclosure, the computing device 100 may project the contour acquired in step S130 onto the 2D vision data. Alternatively, the computing device 100 may project the center point acquired in step S130 onto the 2D vision data. As an example, the computing device 100 may detect the object based on the 2D vision data and the feature information projected onto the 2D vision data. As an example, the computing device 100 may sense the pick point of the object based on the 2D vision data and the feature information projected onto the 2D vision data.

The steps mentioned in the above description may be further split into additional steps, or combined into fewer steps according to an implementation example of the present disclosure. Further, some steps may also be omitted as necessary, and an order between the steps may be changed.

The computing device 100 according to an exemplary embodiment of the present disclosure may acquire 2D vision data (S110), sense an oriented object, acquire a midline point of the oriented object, segment a portion other than the oriented object, sense a contour of the segmented object, acquire a momentum-based center point of the object based on the sensed contour, and project the center point onto the 2D vision data to detect the object. As an example, real-time models for object detection (RTMDet) that has been subjected to subsequent training may be utilized for sensing the oriented object. As used herein, the term “subsequent training” refers to additional training of a pre-trained real-time model for object detection (RTMDet), which includes, but is not limited to, fine-tuning using domain-specific datasets, adjusting hyperparameters, or retraining certain layers of the model to improve detection performance for a specific target object or application. In addition, a segment anything model (SAM) may be utilized to segment the oriented object and the other portion. As an example, the computing device 100 may additionally adjust the RTMDet to increase the efficiency and accuracy of object detection.

As used herein, the term “subsequent training” refers to additional training of a pre-trained model, such as a real-time model for object detection (RTMDet), after an initial training phase has been completed. The subsequent training includes additional training steps performed to adapt the model to a specific task, environment, or domain by utilizing new data, domain-specific datasets, or by modifying hyperparameters.

The subsequent training encompasses various types of re-training techniques, including, but not limited to, fine-tuning, transfer learning, incremental learning, or domain adaptation. In particular, fine-tuning, as a representative example of subsequent training, refers to refining a pre-trained model using labeled data of a specific domain or task, typically by updating model weights partially or fully.

Accordingly, when the present specification refers to a model “subjected to subsequent training,” it is intended to encompass, but is not limited to, fine-tuning and other types of re-training methods known in the art that are performed after the initial training for the purpose of enhancing performance for particular tasks or environments.

FIG. 6 is a schematic diagram for describing a method for detecting an object based on a 2D vision technology for multiple objects according to an exemplary embodiment of the present disclosure.

According to an exemplary embodiment of the present disclosure, the computing device 100 may acquire 2D vision data, and sense an object included in the acquired 2D vision data in the form of a box. In addition, the computing device 100 may calculate and project midline points of the sensed object onto the 2D vision data, and segment the sensed object from a portion other than the object by utilizing an artificial intelligence model. Further, the computing device 100 may acquire a contour of the segment object, and acquire a momentum-based center point of the object based on the contour. Further, the computing device 100 projects the momentum-based center point onto the 2D vision data to detect the object.

As an example, when multiple objects are included in the 2D vision data, the computing device 100 may designate each object as a target of detection. As an example, when multiple objects are superimposed on the 2D vision data, the computing device 100 may detect a closest captured object among the superimposed objects.

Exemplarily referring back to FIG. 6, when there are multiple objects and some objects are superimposed, the computing device 100 may detect an object captured closest to the superimposed objects or an object displayed at a top. In addition, each object may be separately detected for multiple non-superimposed objects.

In the meantime, according to an embodiment of the present disclosure, a computer readable medium storing a data structure is disclosed.

The data structure may refer to organization, management, and storage of data that enable efficient access and modification of data. The data structure may refer to organization of data for solving a specific problem (for example, data search, data storage, and data modification in the shortest time). The data structure may also be defined with a physical or logical relationship between the data elements designed to support a specific data processing function. A logical relationship between data elements may include a connection relationship between user defined data elements. A physical relationship between data elements may include an actual relationship between the data elements physically stored in a computer readable storage medium (for example, a permanent storage device). In particular, the data structure may include a set of data, a relationship between data, and a function or a command applicable to data. Through the effectively designed data structure, the computing device may perform a calculation while minimally using resources of the computing device. In particular, the computing device may improve efficiency of calculation, reading, insertion, deletion, comparison, exchange, and search through the effectively designed data structure.

The data structure may be divided into a linear data structure and a non-linear data structure according to the form of the data structure. The linear data structure may be the structure in which only one data is connected after one data. The linear data structure may include a list, a stack, a queue, and a deque. The list may mean a series of dataset in which order exists internally. The list may include a linked list. The linked list may have a data structure in which data is connected in a method in which each data has a pointer and is linked in a single line. In the linked list, the pointer may include information about the connection with the next or previous data. The linked list may be expressed as a single linked list, a double linked list, and a circular linked list according to the form. The stack may have a data listing structure with limited access to data. The stack may have a linear data structure that may process (for example, insert or delete) data only at one end of the data structure. The data stored in the stack may have a data structure (Last In First Out, LIFO) in which the later the data enters, the sooner the data comes out. The queue is a data listing structure with limited access to data, and may have a data structure (First In First Out, FIFO) in which the later the data is stored, the later the data comes out, unlike the stack. The deque may have a data structure that may process data at both ends of the data structure.

The non-linear data structure may be the structure in which the plurality of data is connected after one data. The non-linear data structure may include a graph data structure. The graph data structure may be defined with a vertex and an edge, and the edge may include a line connecting two different vertexes. The graph data structure may include a tree data structure. The tree data structure may be the data structure in which a path connecting two different vertexes among the plurality of vertexes included in the tree is one. That is, the tree data structure may be the data structure in which a loop is not formed in the graph data structure.

Throughout the present specification, a calculation model, a nerve network, the network function, and the neural network may be used with the same meaning. Hereinafter, the terms of the calculation model, the nerve network, the network function, and the neural network are unified and described with a neural network. The data structure may include a neural network. Further, the data structure including the neural network may be stored in a computer readable medium. The data structure including the neural network may also include preprocessed data for processing by the neural network, data input to the neural network, a weight of the neural network, a hyper-parameter of the neural network, data obtained from the neural network, an active function associated with each node or layer of the neural network, and a loss function for training of the neural network. The data structure including the neural network may include predetermined configuration elements among the disclosed configurations. That is, the data structure including the neural network may include the entirety or a predetermined combination of pre-processed data for processing by neural network, data input to the neural network, a weight of the neural network, a hyper parameter of the neural network, data obtained from the neural network, an active function associated with each node or layer of the neural network, and a loss function for training the neural network. In addition to the foregoing configurations, the data structure including the neural network may include predetermined other information determining a characteristic of the neural network. Further, the data structure may include all type of data used or generated in a computation process of the neural network, and is not limited to the foregoing matter. The computer readable medium may include a computer readable recording medium and/or a computer readable transmission medium. The neural network may be formed of a set of interconnected calculation units which are generally referred to as “nodes”. The “nodes” may also be called “neurons.” The neural network consists of one or more nodes.

The data structure may include data input to the neural network. The data structure including the data input to the neural network may be stored in the computer readable medium. The data input to the neural network may include training data input in the training process of the neural network and/or input data input to the training completed neural network. The data input to the neural network may include data that has undergone pre-processing and/or data to be pre-processed. The pre-processing may include a data processing process for inputting data to the neural network. Accordingly, the data structure may include data to be pre-processed and data generated by the pre-processing. The foregoing data structure is merely an example, and the present disclosure is not limited thereto.

The data structure may include a weight of the neural network (in the present specification, weights and parameters may be used with the same meaning), Further, the data structure including the weight of the neural network may be stored in the computer readable medium. The neural network may include a plurality of weights. The weight is variable, and in order for the neural network to perform a desired function, the weight may be varied by a user or an algorithm. For example, when one or more input nodes are connected to one output node by links, respectively, the output node may determine a data value output from the output node based on values input to the input nodes connected to the output node and the weight set in the link corresponding to each of the input nodes. The foregoing data structure is merely an example, and the present disclosure is not limited thereto.

For a non-limited example, the weight may include a weight varied in the neural network training process and/or the weight when the training of the neural network is completed. The weight varied in the neural network training process may include a weight at a time at which a training cycle starts and/or a weight varied during a training cycle. The weight when the training of the neural network is completed may include a weight of the neural network completing the training cycle. Accordingly, the data structure including the weight of the neural network may include the data structure including the weight varied in the neural network training process and/or the weight when the training of the neural network is completed. Accordingly, it is assumed that the weight and/or a combination of the respective weights are included in the data structure including the weight of the neural network. The foregoing data structure is merely an example, and the present disclosure is not limited thereto.

The data structure including the weight of the neural network may be stored in the computer readable storage medium (for example, a memory and a hard disk) after undergoing a serialization process. The serialization may be the process of storing the data structure in the same or different computing devices and converting the data structure into a form that may be reconstructed and used later. The computing device may serialize the data structure and transceive the data through a network. The serialized data structure including the weight of the neural network may be reconstructed in the same or different computing devices through deserialization. The data structure including the weight of the neural network is not limited to the serialization. Further, the data structure including the weight of the neural network may include a data structure (for example, in the non-linear data structure, B-Tree, Trie, m-way search tree, AVL tree, and Red-Black Tree) for improving efficiency of the calculation while minimally using the resources of the computing device. The foregoing matter is merely an example, and the present disclosure is not limited thereto.

The data structure may include a hyper-parameter of the neural network. The data structure including the hyper-parameter of the neural network may be stored in the computer readable medium. The hyper-parameter may be a variable varied by a user. The hyper-parameter may include, for example, a learning rate, a cost function, the number of times of repetition of the training cycle, weight initialization (for example, setting of a range of a weight value to be weight-initialized), and the number of hidden units (for example, the number of hidden layers and the number of nodes of the hidden layer). The foregoing data structure is merely an example, and the present disclosure is not limited thereto.

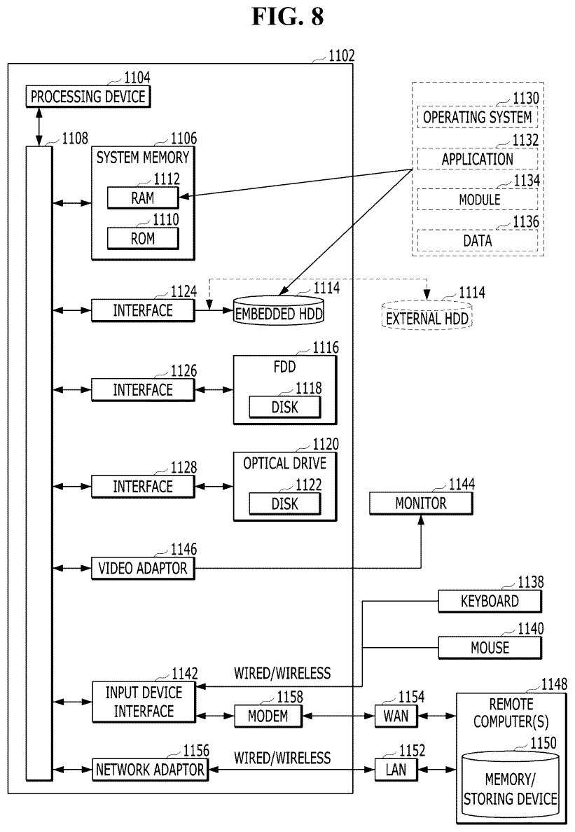

FIG. 8 is a simple and normal schematic view of an exemplary computing environment in which the exemplary embodiments of the present disclosure may be implemented.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transport medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))—the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an outer mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented embodiments is provided so as for those skilled in the art to use or carry out the present disclosure. Various modifications of the embodiments may be apparent to those skilled in the art, and general principles defined herein may be applied to other embodiments without departing from the scope of the present disclosure. Accordingly, the present disclosure is not limited to the embodiments suggested herein, and shall be interpreted within the broadest meaning range consistent to the principles and new characteristics presented herein.

What is claimed is:

1. A method for detecting an object based on a 2D vision technology, the method performed by a computing device, the method comprising:
acquiring 2D vision data;
sensing the object in the acquired 2D vision data;
acquiring feature information of the sensed object; and
detecting the object by projecting at least some of the acquired feature information onto the 2D vision data.

2. The method of claim 1, wherein the sensing of the object in the acquired 2D vision data includes:
acquiring orientation information of the object.

3. The method of claim 2, wherein the sensing of the object in the acquired 2D vision data further includes:
sensing the object by utilizing subsequently trained real-time models for object detection (RTMDet).

4. The method of claim 2, wherein the sensing of the object in the acquired 2D vision data includes:
acquiring midline points of the object.

5. The method of claim 2, wherein the sensing of the object in the acquired 2D vision data further includes:
segmenting the object in the 2D vision data, and
wherein the segmentation utilizes a zero-shot image segmentation method.

6. The method of claim 2, wherein the sensing of the object in the acquired 2D vision data further includes:
segmenting the object in the 2D vision data, and
wherein the segmentation utilizes a segment anything model (SAM).

7. The method of claim 6, wherein the acquiring of the feature information of the sensed object includes:
acquiring contour information of the segmented object.

8. The method of claim 7, wherein the acquiring of the feature information of the sensed object further includes:
acquiring a center point of the segmented object.

9. The method of claim 6, wherein the acquiring of the 2D vision data includes:
receiving the 2D vision data, and
preprocessing the 2D vision data.

10. The method of claim 6, wherein the object has a size equal to or greater than a preset threshold.

11. A computer program stored in a non-transitory computer-readable storage medium, wherein when the computer program is executed by one or more processors, the computer program allows the one or more processors to perform operations for detecting an object based on a 2D vision technology, the operations comprising:
an operation of acquiring 2D vision data;
an operation of sensing the object in the acquired 2D vision data;
an operation of acquiring feature information of the sensed object; and
an operation of detecting the object by projecting at least some of the acquired feature information onto the 2D vision data.

12. The computer program of claim 11, wherein the operation of sensing the object in the acquired 2D vision data includes:
an operation of acquiring orientation information of the object.

13. The computer program of claim 12, wherein the operation of sensing the object in the acquired 2D vision data further includes:
an operation of sensing the object by utilizing subsequently-trained real-time models for object detection (RTMDet).

14. The computer program of claim 12, wherein the operation of sensing the object in the acquired 2D vision data includes:
an operation of acquiring midline points of the object.

15. The computer program of claim 12, wherein the operation of sensing the object in the acquired 2D vision data further includes:
an operation of segmenting the object in the 2D vision data, and
wherein the segmentation utilizes a zero-shot image segmentation method.

16. The computer program of claim 12, wherein the operation of sensing the object in the acquired 2D vision data further includes:
an operation of segmenting the object in the 2D vision data, and
wherein the segmentation utilizes a segment anything model (SAM).

17. The computer program of claim 16, wherein the acquiring of the feature information of the sensed object includes:
an operation of acquiring contour information of the segmented object.

18. The computer program of claim 17, wherein the operation of acquiring the feature information of the sensed object further includes:
an operation of acquiring a center point of the segmented object.

19. The computer program of claim 16, wherein the object has a size equal to or greater than a preset threshold.

20. A computing device comprising:
at least one processor; and
a memory,
wherein the at least one processor is configured to:
acquire 2D vision data,
sense an object in the acquired 2D vision data,
acquire feature information of the sensed object, and
detect the object by projecting at least some of the acquired feature information onto the 2D vision data.
